(19) United States
(12) Patent Application Publication
(10) Pub. No.: US 2023/0167320 A1
(43) Pub. Date: Jun. 1, 2023

(54) Ink Jet Ink Composition And Recording Method

(71) Applicant: SEIKO EPSON CORPORATION, Tokyo (JP)

(72) Inventors: Takuya TAKAHASHI, Matsumoto (JP); Yusuke MIZUTAKI, Shiojiri (JP); Miki UCHIDA, Matsumoto (JP)

(21) Appl. No.: 17/993,022

(22) Filed: Nov. 23, 2022

(30) Foreign Application Priority Data
Nov. 26, 2021 (JP) 2021-192072

(51) Int. Cl. C09D 11/324; C09D 11/38; C09D 11/033; B41M 5/00

(52) U.S. Cl. CPC C09D 11/324; B41M 5/0023; C09D 11/033; C09D 11/38

(57) ABSTRACT

An ink jet ink composition is a water-based ink which contains a colorant; inorganic oxide particles; a watersoluble silicate; and water, and a content of the watersoluble silicate with respect to a total mass of the ink is 0.5 percent by mass or less.

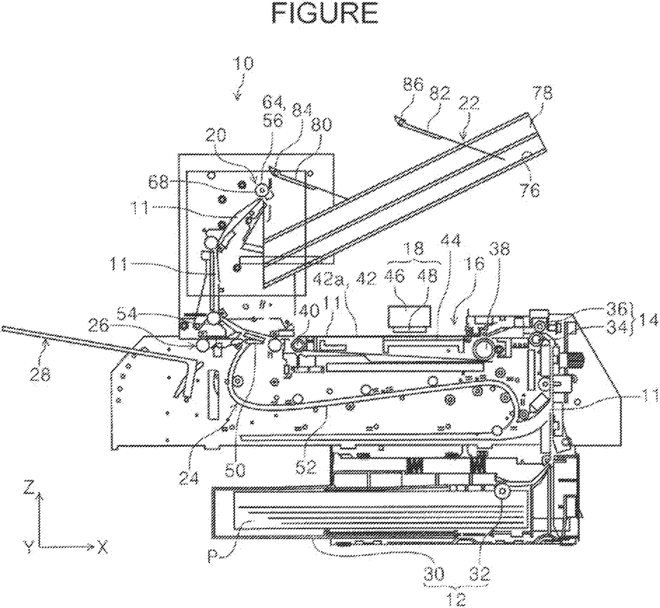

The present application is based on, and claims priority from JP Application Serial Number 2021-192072, filed Nov. 26, 2021, the disclosure of which is hereby incorporated by reference herein in its entirety.

### BACKGROUND

### 1. Technical Field

The present disclosure relates to an ink jet ink composition and a recording method.

### 2. Related Art

Since being able to record a highly fine image by a relatively simple apparatus, an ink jet recording method has been rapidly developed in various fields. In particular, various studies on color development property, ejection stability, and the like have been carried out. For example, in order to provide an ink composition which can form a printed matter having an excellent wet abrasion resistance and the like together with an excellent color development property, JP-A-2020-176235 has disclosed an ink composition which contains pigment particles, a predetermined amount of inorganic oxide particles, and a lactam-based solvent and in which volume average particle diameters of the pigment particles and the inorganic oxide particles are each specified in a predetermined range.

Incidentally, since a nozzle plate of an ink jet head has a preferable water-repellent property, an ink composition to be ejected from a nozzle is configured not to be easily adhered to a nozzle periphery. However, it has become to understand that an ink composition containing inorganic oxide particles as disclosed in JP-A-2020-176235 is not likely to be repelled by a nozzle plate and is liable to be adhered to a nozzle periphery.

### SUMMARY

According to an aspect of the present disclosure, there is provided an ink jet ink composition which is a water-based ink comprising a colorant, inorganic oxide particles, a water-soluble silicate, and water, and a content of the water-soluble silicate with respect to a total mass of the ink is 0.5 percent by mass or less.

According to another aspect of the present disclosure, there is provided a recording method comprising a step of ejecting the ink jet ink composition described above from an ink jet head to a recording medium so as to be adhered thereto.

### BRIEF DESCRIPTION OF THE DRAWINGS

The FIGURE is a schematic view showing one example of a recording apparatus to be used for a recording method of this embodiment.

### DESCRIPTION OF EXEMPLARY EMBODIMENTS

Hereinafter, although an embodiment (hereinafter, referred to as “this embodiment”) of the present disclosure will be described in detail, if needed, with reference to the drawing, the present disclosure is not limited thereto and may be variously changed and/or modified without departing from the scope thereof. In addition, in the drawing, the same element is designated by the same reference numeral, and duplicated description will be omitted. In addition, unless otherwise particularly noted, the positional relationship, such as up to down and/or right to left, is based on the positional relationship shown in the drawing. Furthermore, the dimensional ratio in the drawing is not limited to that shown therein.

### 1. Ink Jet Ink Composition

An ink jet ink composition (hereinafter, also simply referred to as “ink composition” in some cases) according to this embodiment is a water-based ink containing a colorant, inorganic oxide particles, a water-soluble silicate, and water, and a content of the water-soluble silicate with respect to a total mass of the ink is 0.5 percent by mass or less.

Heretofore, when recording is performed using a water-based ink composition on regular paper or the like, there has been a problem in that curling of a recorded matter is generated. Hence, a method to suppress the curling of a recorded matter to be obtained by using an ink composition containing inorganic oxide particles has been known. However, it has become to understand that since a nozzle plate has a low water-repellent property, an ink composition simply containing inorganic oxide particles is liable to be adhered to a nozzle periphery. When the ink adhesion as described above occurs, flight bending occurs thereby, and an intermittent printing stability is degraded; hence, cleaning of the nozzle plate may be required in some cases. In addition, when the ink is dried in the vicinity of the nozzle, since the inorganic oxide particles are precipitated in the form of aggregates, nozzle clogging is generated, and a clogging recovery property is degraded.

On the other hand, in the ink composition of this embodiment, since a predetermined amount of the water-soluble silicate is used together with the inorganic oxide particles, the water-repellent property of the nozzle plate can be improved. Accordingly, besides the suppression of the curling caused by the inorganic oxide particles, the intermittent printing stability can be improved. In addition, when a use amount of the water-soluble silicate is adjusted, the clogging recovery property can also be improved.

Hereinafter, components, physical properties, and a manufacturing method of the ink jet ink composition according to this embodiment will be described.

### 1.1. Colorant

Although the colorant is not particularly limited, for example, a pigment and/or a dye may be mentioned. The colorant may be used alone, or at least two types thereof may be used in combination.

A content of the colorant with respect to the total mass of the ink composition is preferably 0.5 to 15 percent by mass, more preferably 1.0 to 12.5 percent by mass, and further preferably 3.0 to 10 percent by mass. Since the content of the colorant is in the range described above, a color development property tends to be further improved.

### 1.1.1. Pigment

The ink composition of this embodiment may contain a pigment as the colorant. Although the pigment is not particularly limited, for example, there may be used an azo pigment (such as an azo lake, an insoluble azo pigment, a condensed azo pigment, or a chelate azo pigment); a polycyclic pigment (such as a phthalocyanine pigment, a perylene pigment, a perinone pigment, an anthraquinone pigment, a quinacridone pigment, a dioxazine pigment, a thioindigo pigment, an isoindolinone pigment, or a quinophthalone pigment); an organic pigment, such as a nitro pigment, a nitroso pigment, or an aniline black; an inorganic pigment, such as a carbon black (a furnace black, a thermal lamp black, an acetylene black, a channel black, or the like), a metal oxide, a metal sulfide, or a metal chloride; or an extender pigment, such as calcium carbonate or a talc.

The pigment mentioned above may be added to the ink in the form of a pigment dispersion liquid in which the pigment is dispersed in water by a dispersant or in the form of a pigment dispersion liquid obtained by dispersing a self-dispersible type surface-treated pigment which has hydrophilic groups incorporated on its pigment particle surfaces using a chemical reaction (hereinafter, also referred to as “self-dispersible pigment” in some cases) in water or obtained by dispersing a pigment covered with a polymer (hereinafter, also referred to as “resin dispersion pigment” in some cases) in water. Among those mentioned above, the self-dispersible pigment is preferably contained. When the self-dispersible pigment is used, the water-repellent property of the nozzle plate and the intermittent printing stability tend to be further improved.

The pigment and the dispersant to form the pigment dispersion liquid each may be used alone, or at least two types thereof may be used in combination.

### 1.1.2. Dye

Although the dye is not particularly limited, for example, there may be mentioned an acid dye, such as C.I. Acid Yellow, C.I. Acid Red, C.I. Acid Blue, C.I. Acid Orange, C.I. Acid Violet, or C.I. Acid Black; a basic dye, such as C.I. Basic Yellow, C.I. Basic Red, C.I. Basic Blue, C.I. Basic Orange, C.I. Basic Violet, or C.I. Basic Black; a direct dye, such as C.I. Direct Yellow, C.I. Direct Red, C.I. Direct Blue, C.I. Direct Orange, C.I. Direct Violet, or C.I. Direct Black; a reactive dye, such as C.I. Reactive Yellow, C.I. Reactive Red, C.I. Reactive Blue, C.I. Reactive Orange, C.I. Reactive Violet, or C.I. Reactive Black; or a dispersive dye, such as C.I. Disperse Yellow, C.I. Disperse Red, C.I. Disperse Blue, C.I. Disperse Orange, C.I. Disperse Violet, or C.I. Disperse Black. The dyes mentioned above may be used alone, or at least two types thereof may be used in combination.

### 1.2. Inorganic Oxide Particles

Although the inorganic oxide particles are not particularly limited, for example, there may be mentioned silica particles, alumina particles, titania particles, zirconia particles, antimony oxide particles, tin oxide particles, tantalum oxide particles, zinc oxide particles, cerium oxide particles, lead oxide particles, or indium oxide particles. Among those mentioned above, the silica particles are preferable. Since the inorganic oxide particles as described above are used, the curling of a recorded matter to be obtained can be further suppressed. In addition, as the inorganic oxide particles, one type thereof may be used alone, or at least two types thereof may be used in combination.

The particles of the inorganic oxide particles may be surface-treated particles. For example, the silica may be surface-treated with alumina. Accordingly, a pH range in which the silica can be stably dispersed is increased, and a dispersion stability tends to be further improved.

As the silica described above, a commercially available product may also be used, and for example, there may be mentioned SI-45P, SI-80, SI-30P, or S-40 each of which is Cataloid Series manufactured by JGC Catalysts and Chemicals Ltd., or Snowtex 20, Snowtex 30P, Snowtex 40, Snowtex O, Snowtex N, or Snowtex C, manufactured by Nissan Chemical Corporation. Among those mentioned above, since the advantage of the present disclosure can be more effectively and reliably achieved, SI-45P and/or SI-80 is preferably used.

An average particle diameter of the inorganic oxide particles is preferably 10 to 200 nm, more preferably 20 to 150 nm, and further preferably 30 to 100 nm. Since the average particle diameter of the inorganic oxide particles is 200 nm or less, the color development property, the intermittent printing stability, and the clogging recovery property tend to be further improved. In addition, since the average particle diameter of the inorganic oxide particles is 10 nm or more, the curling tends to be further suppressed.

The average particle diameter of the inorganic oxide particles can be measured by a particle size distribution measurement device using a dynamic light scattering method as a measurement principle. As the particle size distribution measurement device described above, for example, there may be mentioned a “zeta-potential /particle size/molecular weight measurement system ELSZ2000ZS” (trade name, manufactured by Otsuka Electronics Co., Ltd.) using a homodyne optical system as a frequency analysis method. In addition, in this specification, unless otherwise particularly noted, the “average particle diameter” indicates an average particle diameter based on the number of particles.

A content of the inorganic oxide particles as a solid content with respect to the total mass of the ink is preferably 1.0 to 10 percent by mass, more preferably 2.0 to 9.0 percent by mass, and further preferably 3.0 to 8.0 percent by mass. Since the content of the inorganic oxide particles is 1.0 percent by mass or more, the curling of a recorded matter to be obtained is further suppressed, and hence, a transport rate of a recording medium can be further improved. In addition, since the content of the inorganic oxide particles is 10 percent by mass or less, the color development property, the water-repellent property of the nozzle plate, the intermittent printing stability, and the clogging recovery property tend to be further improved.

The content of the inorganic oxide particles on a mass basis is preferably higher than the content of the water-soluble silicate which will be described later. A ratio of the content of the inorganic oxide particles to the content of the water-soluble silicate (inorganic oxide particles/water-soluble silicate) is preferably 3 to 50,000, more preferably 5 to 25,000, and further preferably 5 to 10,000. Since the ratio (inorganic oxide particles/water-soluble silicate) is in the range described above, the curling is further suppressed, and the color development property, the water-repellent property of the nozzle plate, the intermittent printing stability, and the clogging recovery property tend to be further improved.

A content of a solid content of this embodiment with respect to the total mass of the ink composition is preferably 5.0 percent by mass or more, more preferably 6.0 to 20 percent by mass, even more preferably 7.0 to 15 percent by mass, and further preferably 8.0 to 12.5 percent by mass. Since the content of the solid content is in the range described above, the color development property of a recorded matter to be obtained tends to be easily suppressed from being degraded. In addition, the solid content includes the inorganic oxide particles and the colorant.

### 1.3. Water-Soluble Silicate

The ink composition of this embodiment contains a water-soluble silicate. Since the inorganic oxide particles described above and the water-soluble silicate are used in combination, the water-repellent property of the nozzle plate is improved, and the intermittent printing stability is further improved.

The water-soluble silicate is not particularly limited, and for example, an alkali metal salt of a silicic acid or an ammonium salt of a silicic acid may be mentioned. The alkali metal salt of a silicic acid is formed from silicon dioxide and a metal oxide and is not particularly limited as long as being a compound having a water solubility, and for example, an alkali metal salt of metasilicic acid or an alkali metal salt of orthosilicic acid may be mentioned. In addition, as the ammonium salt of a silicic acid, for example, an ammonium salt of methasilicic acid or an ammonium salt of orthosilicic acid may be mentioned. Furthermore, in this embodiment, the “water soluble compound” indicates a compound to be dissolved in water at 20° C. at a content of 1 percent by mass or more. The water-soluble silicate may be used alone, or at least two types thereof may be used in combination.

In particular, the alkali metal silicate or the ammonium silicate is preferably at least one type of compound represented by the following general formula (1).

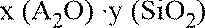

In the general formula (1), A represents sodium, potassium, or tetraalkylammonium (NR₄), x represents 1 or 2, and y represent an integer of 1 to 4. R represents an alkyl group (methyl, ethyl, propyl, or butyl) having 1 to 4 carbon atoms.

The alkyl metal silicate represented by the general formula (1) (A=alkyl metal) is called an alkyl metal metasilicate when x=1 and y=1 are satisfied and is called an alkyl metal orthosilicate when x=2 and y=1 are satisfied, and those compounds are each a water-soluble alkali metal silicate.

In addition, the ammonium silicate represented by the general formula (1) (A=tetraalkylammonium) is called a tetraalkyl ammonium metasilicate when x=1 and y=1 are satisfied and is called a tetraalkyl ammonium orthosilicate when x=2 and y=1 are satisfied, and those compounds are each a water-soluble ammonium silicate.

A content of the water-soluble silicate with respect to the total mass of the ink composition is 0.5 percent by mass or less, preferably 0.00001 to 0.5 percent by mass, more preferably 0.0005 to 0.5 percent by mass, even more preferably 0.001 to 0.5 percent by mass, further preferably 0.005 to 0.5 percent by mass, and even further preferably 0.01 to 0.4 percent by mass. Since the content of the water-soluble silicate is 0.5 percent by mass or less, the clogging recovery property tends to be further improved. In addition, since the content of the water-soluble silicate is 0.00001 percent by mass or more, the water-repellent property of the nozzle plate is improved, and the intermittent printing stability tends to be further improved.

### 1.4. Water

The ink composition of this embodiment is a water-based ink composition containing water. The water-based ink is an ink at least containing water as a primary solvent component.

A content of the water with respect to the total mass of the ink is preferably 30 percent by mass or more. In addition, the content of the water described above is preferably 98 percent by mass or less, more preferably 80 percent by mass or less, even more preferably 40 to 75 percent by mass, and further preferably 50 to 70 percent by mass. Since the content of the water is in the range described above, even when the water is partially evaporated, an increase in viscosity of the ink is suppressed, and the clogging recovery property tends to be further improved. In addition, since the content of the water is 90 percent by mass or less, the curling tends to be further suppressed.

### 1.5. Water-Soluble Organic Solvent

The ink composition of this embodiment preferably contains a water-soluble organic solvent. Since the ink composition contains a water-soluble organic solvent, a storage stability tends to be further improved.

Although the water-soluble organic solvent is not particularly limited, for example, there may be mentioned glycerin, N-methyl pyrrolidone, ethylene glycol, diethylene glycol, triethylene glycol, propylene glycol, dipropylene glycol, tripropylene glycol, propanediol, butanediol, pentanediol, or hexylene glycol. Among those mentioned above, in view of moisture retaining effect, glycerin is preferable.

A content of the water-soluble organic solvent with respect to the total mass of the ink is preferably 0.5 to 40 percent by mass, more preferably 1 to 20 percent by mass, even more preferably 3 to 15 percent by mass, and further preferably 5 to 12 percent by mass.

A content of a water-soluble organic solvent S₁ having an SP value of 27.5 (J/cm³) ^{½} or less with respect to a total mass of the water-soluble organic solvent is preferably 35 percent by mass or less. The content of the water-soluble organic solvent S₁ with respect to the total mass of the water-soluble organic solvent is more preferably 5.0 to 32 percent by mass, even more preferably 10 to 30 percent by mass, and further preferably 15 to 28 percent by mass. Since the content of the water-soluble organic solvent S₁ is in the range described above, the storage stability tends to be further improved.

In addition, the SP value indicates a solubility parameter, and in this specification, the SP value is a value defined by a regular theory introduced by Hildebrand. The SP value of an organic solvent is a value obtained by calculation from the evaporation energy and mole volume of atoms and atom groups by Fedors described in Coating Basics and Engineering (p. 53, authored by Yuji Harasaki, published by Converting Technical Institute). The unit of the SP value of this embodiment is (J/cm³) ^{½} and can be converted into the unit of (cal/m³) ^{½} using 2.046X10³ (J/m³) ^{½} = 1 (cal/cm³₎ ^{½}.

The water-soluble organic solvent S₁ having an SP value of 27.5 (J/cm³) ^{½} or less is not particularly limited, and for example, there may be mentioned triethylene glycol monobutyl ether (BTG, also called butyl triglycol, SP value: 21.1), triethylene glycol monomethyl ether (MTG, also called methyl triglycol, SP value: 22.1), 2-methylpentane-1,3-diol (SP value: 21.1), 2-methylpentane-1,4-diol, ethylene glycol monoethyl ether (SP value: 21.5), ethylene glycol monobutyl ether (SP value: 19.4), diethylene glycol monoethyl ether (SP value: 20.9), diethylene glycol monobutyl ether (SP value: 20.9), or ethylene glycol diacetate (SP value: 20.5). Among those mentioned above, triethylene glycol monobutyl ether or triethylene glycol monomethyl ether is preferable.

A water-soluble organic solvent other than those mentioned above is not particularly limited, and for example, there may be mentioned glycerin, propylene glycol, triethylene glycol, or a glycol monoether. Among those mentioned above, since the advantage of the present disclosure can be more effectively and reliably achieved, the ink composition preferably contains glycerin and/or triethylene glycol.

A content of the water-soluble organic solvent with respect to the total mass of the ink is preferably 0.5 to 25 percent by mass, more preferably 3.0 to 20 percent by mass, and further preferably 5.0 to 15 percent by mass. Since the content of the water-soluble organic solvent is in the range described above, the storage stability tends to be further improved.

### 1.6. Amino Acid

The ink composition of this embodiment preferably contains an amino acid. In this specification, the amino acid indicates a compound having an amino group and a carboxy group in one molecule. By the use of the amino acid, the storage stability and the clogging recovery property tend to be further improved.

As the amino acid contained in the ink composition is not particularly limited, and for example, there may be mentioned a tertiary amino acid, such as dimethyl glycine, dimethyl alanine, dimethyl glutamic acid, or diethyl glycine; or a quaternary amino acid, such as trimethyl glycine, trimethyl alanine, trimethyl glutamic acid, or triethyl glycine. Among those mentioned above, a quaternary amino acid having a quaternary ammonium group is preferable, and trimethyl glycine is more preferable. By the use of the amino acid as described above, the storage stability and the clogging recovery property tend to be further improved. In addition, the amino acid may be used alone, or at least two types thereof may be used in combination.

A content of the amino acid with respect to the total mass of the ink composition is preferably 1.0 to 20 percent by mass, more preferably 2.0 to 10 percent by mass, and further preferably 3.0 to 7.0 percent by mass. Since the content of the amino acid is in the range described above, the storage stability and the clogging recovery property of a recorded matter to be obtained tend to be further improved.

### 1.7. Surfactant

The ink composition of this embodiment may contain a surfactant. The surfactant is not particularly limited, and for example, there may be mentioned an acetylene glycol-based surfactant, a fluorine-based surfactant, or a silicone-based surfactant. Among those mentioned above, in view of the clogging recovery property, the acetylene glycol-based surfactant is preferable.

The acetylene glycol-based surfactant is not particularly limited, and for example, at least one selected from 2,4,7,9-tetramethyl-5-decyne-4,7-diol, an alkylene oxide adduct thereof, 2,4-dimethyl-5-decyne-4-ol, and an alkylene oxide adduct thereof is preferable. Although a commercially available product of the acetylene glycol-based surfactant is not particularly limited, for example, there may be mentioned Olfine 104 Sereis or E Series such as Olfine E1010 (trade name, manufactured by Air Products & Chemicals Inc.) or Surfynol 61, 104, or 465 (trade name, manufactured by Nisshin Chemical Industry Co., Ltd.). Among those mentioned above, since the advantage of the present disclosure can be more effectively and reliably achieved, OLfine E1010 and/or Surfynol 104 is preferably contained. In addition, the acetylene glycol-based surfactant may be used alone, or at least two types thereof may be used in combination.

Although the fluorine-based surfactant is not particularly limited, for example, there may be mentioned a perfluoroalkyl sulfonate salt, a perfluoroalkyl carboxylate salt, a perfluoroalkyl phosphate ester, a perfluoroalkyl ethylene oxide adduct, a perfluoroalkyl alkyl betaine, or a perfluoroalkylamine oxide compound. A commercially available product of the fluorine-based surfactant is not particularly limited, and for example, there may be mentioned S-144 or S-145 (manufactured by Asahi Glass Co., Ltd.); FC-170C, FC-430, or Fluorad FC4430 (manufactured by Sumitomo 3M Limited); FSO, FSO-100, FSN, FSN-100, or FS-300 (manufactured by du Pont); or FT-250 or 251 (manufactured by Neos Co., Ltd.). In addition, the fluorine-based surfactant may be used alone, or at least two types thereof may be used in combination.

As the silicone-based surfactant, for example, a polysiloxane-based compound or a polyether modified organosiloxane may be mentioned. A commercially available product of the silicone-based surfactant is not particularly limited, and for example, there may be mentioned BYK-306, BYK-307, BYK-333, BYK-341, or BYK-345 (trade name, manufactured by BYK Japan KK); or KF-351A, KF-352A, KF-353, KF-354L, or KF-355A (trade name, manufactured by Shin-Etsu Chemical Co., Ltd.).

A content of the surfactant with respect to the total mass of the ink is preferably 0.1 to 5.0 percent by mass and more preferably 0.2 to 3.0 percent by mass. Since the content of the surfactant is in the range described above, the clogging recovery property tends to be further improved.

### 1.7. Method for Manufacturing Ink Jet Ink Composition

A method for manufacturing an ink jet ink composition according to this embodiment is not particularly limited, and for example, there may be mentioned a method in which a colorant, inorganic oxide particles, a water-soluble silicate, and water are prepared so that a content of the water-soluble silicate with respect to a total mass of the ink is 0.5 percent by mass or less and are then mixed together. In addition, the inorganic oxide particles may be mixed in the form of a colloidal solution, and when a pigment is used, the inorganic oxide particles may be mixed in the form of a pigment dispersion liquid.

### 2. Ink Jet Method

An ink jet method according to this embodiment includes an ejection step of ejecting the ink jet ink composition described above using a predetermined ink jet head so as to be adhered to a recording medium and a transport step of transporting the recording medium. In addition, the ejection step and the transport step may be simultaneously or alternately performed.

### 2.1. Ejection Step

In the ejection step, the ink is ejected from an ink jet head and then adhered to the recording medium. In more particular, a pressure generating device provided in the ink jet head is driven, and the ink filled in a pressure generating chamber in the ink jet head is ejected from a nozzle. The ejection method as described above is also called an ink jet method.

As the ink jet head used in the ejection step, a line head to perform recording by a line method and a serial head to perform recording by a serial method are mentioned.

In the line method using a line head, for example, an ink jet head having a width equal to or larger than a recording width of a recording medium is fixed in a recording apparatus. Subsequently, the recording medium is transferred in a sub-scanning direction (transport direction of the recording medium), and in conjunction with this transfer, ink droplets are ejected from the nozzle of the ink jet head, so that an image is recorded on the recording medium.

In the serial method using a serial head, for example, an ink jet head is mounted on a carriage movable in a width direction of a recording medium. Subsequently, the carriage is transferred along a main scanning direction (width direction of the recording medium), and in conjunction with this transfer, ink droplets are ejected from the nozzle of the ink jet head, so that an image is recorded on the recording medium.

### 2.2. Transport Step

The transport step transports the recording medium in a predetermined direction in the recording apparatus. In more particular, using a transport roller and/or a transport belt provided in the recording apparatus, the recording medium is transported from a paper feed portion to a paper discharge portion in the recording apparatus. In this transport step, the ink ejected from the ink jet head is adhered to the recording medium, so that a recorded matter is formed. The transport may be performed continuously or intermittently.

### 2.3. Recording Medium

A recording medium used in this embodiment is not particularly limited, and for example, an absorbing or a non-absorbing recording medium may be mentioned. Among those mentioned above, since the absorbing recording medium is liable to cause a problem, such as curling, the ink composition of the present disclosure having an excellent clogging recovery property is effective although using the inorganic oxide particles. That is, the ink composition of this embodiment is preferably used for recording on the absorbing recording medium.

Although the absorbing recording medium is not particularly limited, as examples thereof, there may be mentioned regular paper, such as electrophotographic paper, having a high ink permeability; ink jet paper (ink jet exclusive paper which includes an ink absorbing layer formed from silica particles or alumina particles or an ink absorbing layer formed from a hydrophilic polymer, such as a poly(vinyl alcohol) (PVA) or a poly(vinyl pyrrolidone) (PVP)); and art paper, coated paper, or cast paper which has a relatively low ink permeability and which is used for general offset printing.

Although the non-absorbing recording medium is not particularly limited, for example, there may be mentioned a film or a plate of a plastic, such as a poly(vinyl chloride), a polyethylene, a polypropylene, a poly(ethylene terephthalate) (PET), a polycarbonate, a polystyrene, or a polyurethane; a plate of a metal, such as iron, silver, copper, or aluminum; a metal plate or a plastic-made film formed by deposition of at least one of the various types of metals mentioned above; a plate of an alloy, such as stainless steel or brass; or a recording medium in which a film of a plastic, such as a poly(vinyl chloride), a polyethylene, a polypropylene, a poly(ethylene terephthalate) (PET), a polycarbonate, a polystyrene, or a polyurethane, is adhered (coated) on a paper-made substrate.

### 3. Recording Apparatus

A recording apparatus of this embodiment includes an ink jet head having at least one nozzle to eject an ink jet ink composition to a recording medium and a transport device to transport the recording medium. The ink jet head includes a pressure chamber to which the ink is supplied and the nozzle to eject the ink. In addition, the transport device is formed from a transport roller and/or a transport belt provided in the recording apparatus.

Hereinafter, the recording apparatus according to this embodiment will be described with reference to FIGURE. In addition, in the X-Y-Z coordinate system shown in FIGURE, an X direction indicates a length direction of the recording medium, a Y direction indicates a width direction of the recording medium in a transport path in the recording apparatus, and a Z direction indicates a height direction of the apparatus.

As one example of a recording apparatus 10, a line type ink jet printer capable of performing printing at a high speed and at a high density will be described. The recording apparatus 10 includes a feed portion 12 to store a recording medium P such as paper, a transport portion 14, a belt transport portion 16, a record portion 18, an Fd (facedown) discharge portion 20 functioning as a “discharge portion”, an Fd (facedown) stage 22 functioning as a “stage”, a reverse path portion 24 functioning as a “reverse transport mechanism”, an Fu (faceup) discharge portion 26, and an Fu (faceup) stage 28.

The feed portion 12 is disposed at a lower side of the recording apparatus 10. The feed portion 12 includes a feed tray 30 to store the recording medium P and a feed roller 32 to feed the recording medium P stored in the feed tray 30 to a transport path 11.

The recording medium P stored in the feed tray 30 is fed to the transport portion 14 along the transport path 11 by the feed roller 32. The transport portion 14 includes a transport drive roller 34 and a transport driven roller 36. The transport drive roller 34 is rotationally driven by a driving source not shown. In the transport portion 14, the recording medium P is nipped between the transport drive roller 34 and the transport driven roller 36 and is then transported to the belt transport portion 16 located downstream of the transport path 11.

The belt transport portion 16 includes a first roller 38 located upstream of the transport path 11, a second roller 40 located downstream thereof, an endless belt 42 fitted to the first roller 38 and the second roller 40 in a rotationally transferable manner, and a support body 44 to support an upper-side section 42a of the endless belt 42 between the first roller 38 and the second roller 40.

The endless belt 42 is driven by the first roller 38 driven by the driving source not shown or the second roller 40 so as to be transferred from a +X direction to a -X direction in the upper-side section 42a. Hence, the recording medium P transported from the transport portion 14 is further transported downstream of the transport path 11 in the belt transport portion 16.

The record portion 18 includes a line type ink jet head 48 and a head holder 46 to hold the ink jet head 48. In addition, the record portion 18 may also be a serial type in which an ink jet head is mounted on a carriage which is reciprocally transferred in a Y axis direction. The ink jet head 48 is disposed so as to face the upper-side section 42a of the endless belt 42 supported by the support body 44. When the recording medium P is transported in the upper-side section 42a of the endless belt 42, the ink jet head 48 ejects the ink to the recording medium P, so that the recording is carried out. While the recording is carried out, the recording medium P is transported downstream of the transport path 11 by the belt transport portion 16.

In addition, the “line type ink jet head” is a head used for the recording apparatus in which a nozzle region formed in a direction intersecting the transport direction of the recording medium P is provided so as to cover the entire recording medium P in the intersecting direction, and while one of the head and the recording medium P is fixed, the other is transferred to form an image. In addition, the nozzle region of the line head in the intersecting direction may not cover the entire recording medium P in the intersecting direction in the recording apparatus.

In addition, at downstream of the transport path 11 of the belt transport portion 16, a first branch portion 50 is provided. The first branch portion 50 is configured to switchably communicate with one of the transport path 11 to transport the recording medium P to the Fd discharge portion 20 or the Fu discharge portion 26 and a reverse path 52 of the reverse path portion 24 in which after a recording surface of the recording medium P is reversed, the recording medium P is again transported to the record portion 18. In addition, the recording medium P to be transported after the transport path 11 is switched to the reverse path 52 by the first branch portion 50 is processed such that the recording surface thereof is reversed in a transport process in the reverse path 52 and is again transported to the record portion 18 so that a surface of the recording medium P opposite to the original recording surface faces the ink jet head 48.

At downstream of the first branch portion 50 along the transport path 11, a second branch portion 54 is further provided. The second branch portion 54 is configured so as to transport the recording medium P to one of the Fd discharge portion 20 and the Fu discharge portion 26 by switching the transport direction of the recording medium P.

The recording medium P transported to the Fd discharge portion 20 by the second branch portion 54 is discharged from the Fd discharge portion 20 and then placed on the Fd stage 22. In this case, the recording surface of the recording medium P is placed so as to face the Fd stage 22. In addition, the recording medium P transported to the Fu discharge portion 26 by the second branch portion 54 is discharged from the Fu discharge portion 26 and then placed on the Fu stage 28. In this case, the recording surface of the recording medium P is placed so as to face a side opposite to the Fu stage 28.

In addition, although the case in which the line type ink jet head is used has been described above by way of example, the recording apparatus of this embodiment may be a printer (serial printer) using a serial type ink jet head. In the serial printer, while a recording medium is transported in a transport direction, the ink jet head is transferred in a direction intersecting the transport direction described above, so that the recording is performed.

### EXAMPLES

Hereinafter, the present disclosure will be described in more detail with reference to Examples and Comparative Examples. The present disclosure is not limited at all to the following Examples.

### 1. Preparation of Ink Composition

After components were charged in a mixing tank so as to have one of the compositions described in Tables 1 to 3 and then mixed and stirred, filtration was performed using a 5-µm membrane filter, so that the ink jet ink compositions of Examples and Comparative Examples were obtained. In addition, unless otherwise particularly noted, the numerical value of each component of each Example in the table represents percent by mass. In addition, in the table, the numerical values of the inorganic oxide particles and the pigment dispersion liquid each represent a percent by mass of a solid content.

The abbreviations and the details of the product components shown in Tables 1 to 3 are as described below, and the numerical value at the right side of the abbreviation of the solvent represents the SP value thereof.

PIGMENT DISPERSION LIQUID
Resin dispersion carbon black (MICROPIGMO WMBK-71, manufactured by Orient Chemical Industries Co., Ltd.)
Self-dispersible carbon black (CAB-O-JET300, manufactured by Cabot Corporation)

WATER-SOLUBLE SILICATE
Potassium silicate (manufactured by Nippon Chemical Industrial Co., Ltd.)
Sodium silicate (manufactured by Nippon Chemical Industrial Co., Ltd.)

INORGANIC OXIDE PARTICLES
Cataloid SI-45P (trade name of Cataloid Series, average particle diameter: 45 nm, manufactured by JGC Catalysts and Chemicals Ltd.)
Cataloid SI-80 (trade name of Cataloid Series, average particle diameter: 80 nm, manufactured by JGC Catalysts and Chemicals Ltd.)

SOLVENT (WATER-SOLUBLE ORGANIC SOLVENT)
BTG (triethylene glycol monobutyl ether, SP value: 21.1)
MTG (triethylene glycol monomethyl ether, SP value: 22.1)
TEG (triethylene glycol, SP value: 27.54)
Glycerin (SP value: 34.2)

SURFACTANT
Olfine E1010 (trade name, acetylene glycol-based surfactant, manufactured by Air Products & Chemicals Inc.)
Surfynol 104 (trade name, acetylene glycol-based surfactant, manufactured by Nisshin Chemical Industry Co., Ltd. )

AMINO ACID
Trimethyl glycine (manufactured by du Pont)

### 2. Evaluation Method

### 2.1. Color Development Property

The ink composition thus manufactured was filled in an ink cartridge of an ink jet printer “PX-S7050” (trade name, manufactured by Seiko Epson Corporation). As a recording medium, A4-size (210 mm×297 mm) copy paper “Xerox P paper” (trade name, basis weight: 64 g/m², paper thickness: 88 µm, manufactured by Fuji Xerox Co., Ltd.) was prepared. A solid pattern was printed on this recording medium at a printing duty of 100%. After the printing, an optical density (hereinafter, also referred to as “OD value” in some cases) was measured using a colorimeter “Xrite i1” (trade name, manufactured by Xrite), and the color development property was then evaluated in accordance with the following measurement criteria.

MEASUREMENT CRITERIA
A: maximum OD value of 1.2 or more
B: maximum OD value of 1.1 to less than 1.2
C: maximum OD value of less than 1.1

### 2.2. Storage Stability

After the ink composition was received in an ink pack, the ink pack was tightly sealed and then stored at 70° C. for 6 days. The viscosities of the ink composition before and after the storage were measured at 20° C. using a reverse-flow type Cannon-Fenske viscometer, and an increase in viscosity before and after the storage was calculated. An ink storage stability was evaluated based on the result in accordance with the following evaluation criteria.

EVALUATION CRITERIA
A: increase in viscosity of less than 0.1 mm²/s
B: increase in viscosity of 0.1 to less than 0.3 mm²/s
C: increase in viscosity of 0.3 mm²/s or more

### 2.3. Intermittent Printing Stability

After a ruled line was recorded in an environment at a temperature of 30° C. and a humidity of 20% by an ink jet printer PX-S7050 using the ink composition thus prepared, idle running of the head was performed for 40 seconds, and a ruled line was again recorded. By comparison between the ruled lines before and after the idle running, a landing deviation amount of the ink was measured. Based on the result thus obtained, the intermittent printing stability was evaluated in accordance with the following evaluation criteria.

EVALUATION CRITERIA
A: landing deviation amount of less than 30 µm
B: landing deviation amount of 30 to less than 50 µm
C: landing deviation amount of 50 to less than 70 µm
D: landing deviation amount of 70 µm or more

### 2.4. Evaluation of Clogging Recovery Property

After the ink was filled in an ink cartridge of an ink jet printer PX-S7050, the ejection of the ink from all nozzles was confirmed. Subsequently, in the state in which the ink jet head is located apart from a position of a cap provided in the head, that is, in the state in which the head is not capped, the ink jet head was left in an environment at a temperature of 40° C. and a humidity of 20% for 7 days.

After the ink jet head was left as described above, a suction operation of the ink in the nozzle was performed as the cleaning of the ink jet head. At each cleaning operation, the number of nozzles from each of which the ink was not ejected was counted, and until all the nozzles were recovered, the cleaning operation was repeatedly performed. Subsequently, based on the number of cleanings at which all the nozzles were recovered, the clogging recovery property was evaluated in accordance with the following evaluation criteria.

EVALUATION CRITERIA
A: Number of cleanings is less than 6.
B: Number of cleanings is 6 to less than 9.
C: Number of cleanings is 9 or more, or some nozzles are not recovered.

### 2.5. Evaluation of Primary Curling

After the ink was filled in an ink cartridge of an ink jet printer PX-S7050, a solid pattern was printed at a printing duty of 100% on a recording medium (postcard-size Xerox P paper, copy paper having a basis weight of 64 g/m² and a paper thickness of 88 µm, manufactured by Fuji Xerox Co., Ltd.) in an environment at a temperature of 25° C. and a humidity of 50%. Subsequently, after the printing was performed, the recording medium was left facedown, and an angle formed between a point at which the paper was in contact with a floor surface and the paper end was measured as an index of primary curling. The primary curling was evaluated in accordance with the following evaluation criteria.

EVALUATION CRITERIA
A: maximum curling angle of less than 90°
B: maximum curling angle of 90° to less than 110°
C: maximum curling angle of 110° or more

### 2.6. Water-Repellent Property of Nozzle Plate

After 5 µL of the ink composition of each Example was dripped at 25° C. on a silicon nozzle plate which was formed from single crystal silicon and which was provided with a water-repellent film, a contact angle with the nozzle plate was measured at an elapsed time of 100 ms after the dripping of the ink composition. As a contact angle meter, a portable contact angle meter PCA-1 (manufactured by Kyowa Interface Science Co., Ltd.) was used. The water-repellent property of the nozzle plate was evaluated in accordance with the following evaluation criteria.

EVALUATION CRITERIA
A: contact angle of 60° or more
B: contact angle of 40° to less than 60°
C: contact angle of less than 40°

TABLE 1

| | | EXAMPLE | | | | | | |
|---|---|---|---|---|---|---|---|---|
| | | 1 | 2 | 3 | 4 | 5 | 6 | 7 |
| PIGMENT (CARBON BLACK) | RESIN DISPERSION | | | | | | | |
| | SELF DISPERSION | 7.0 | 7.0 | 7.0 | 7.0 | 7.0 | 6.0 | 6.0 |
| WATER-SOLUBLE SILICATE | POTASSIUM SILICATE | 0.0001 | 0.0010 | 0.1000 | 0.3000 | 0.5000 | 0.0010 | 0.0010 |
| | SODIUM SILICATE | | | | | | | |
| INORGANIC OXIDE PARTICLES | CATALOID SI-45P | 3.0 | 3.0 | 3.0 | 3.0 | 3.0 | 5.0 | 7.0 |
| | CATALOID SI-80 | | | | | | | |
| SOLVENT | BTG (21.1) | 1.0 | 1.0 | 1.0 | 1.0 | 1.0 | 1.0 | 1.0 |
| | MTG (22.1) | 2.0 | 2.0 | 2.0 | 2.0 | 2.0 | 2.0 | 2.0 |
| | TEG (27.54) | 1.0 | 1.0 | 1.0 | 1.0 | 1.0 | 1.0 | 1.0 |
| | GLYCERIN (34.2) | 7.0 | 7.0 | 7.0 | 7.0 | 7.0 | 7.0 | 7.0 |
| SURFACTANT | OLFINE E1010 | 0.5 | 0.5 | 0.5 | 0.5 | 0.5 | 0.5 | 0.5 |
| | SURFYNOL 104 | 0.5 | 0.5 | 0.5 | 0.5 | 0.5 | 0.5 | 0.5 |
| AMINO ACID | TRIMETHYL GLYCINE | 6.0 | 6.0 | 6.0 | 6.0 | 6.0 | 6.0 | 6.0 |
| WATER | | 66.0 | 66.0 | 66.0 | 66.0 | 66.0 | 64.0 | 62.0 |
| TOTAL | | 100 | 100 | 100 | 100 | 100 | 100 | 100 |
| SOLID CONTENT | | 10.0 | 10.0 | 10.0 | 10.0 | 10.0 | 11.0 | 13.0 |
| MASS RATIO (INORGANIC OXIDE PARTICLES/SILICATE) | | 30000 | 3000 | 30 | 10 | 6 | 5000 | 7000 |
| SOLVENT S₁ HAVING SP VALUE OF 27.5 OR LESS/TOTAL SOLVENT (%) | | 27.27 | 27.27 | 27.27 | 27.27 | 27.27 | 27.27 | 27.27 |
| EVALUATION ITEM | COLOR DEVELOPMENT PROPERTY | A | A | A | A | A | B | B |
| | STORAGE STABILITY | A | A | A | A | A | A | A |
| | INTERMITTENT PRINTING STABILITY | C | B | B | B | A | C | B |
| | CLOGGING RECOVERY PROPERTY | A | A | A | B | B | B | B |
| | PRIMARY CURLING | B | B | B | B | B | A | A |
| | NOZZLE-PLATE HYDROPHOBIC PROPERTY | B | B | A | A | A | B | B |

*VALUE IN PARENTHESES OF SOLVENT: SP VALUE [(J/cm³)^{½}]

TABLE 2

| | | EXAMPLE | | | | | | |
|---|---|---|---|---|---|---|---|---|
| | | 8 | 9 | 10 | 11 | 12 | 13 | 14 |
| PIGMENT (CARBON BLACK) | RESIN DISPERSION | | 7.0 | | | | | |
| | SELF DISPERSION | 6.0 | | 4.0 | 3.0 | 7.0 | 7.0 | 7.0 |
| WATER-SOLUBLE SILICATE | POTASSIUM SILICATE | 0.0010 | 0.1000 | 0.1000 | 0.1000 | | 0.1000 | 0.1000 |
| | SODIUM SILICATE | | | | | 0.1 | | |
| INORGANIC OXIDE PARTICLES | CATALOID SI-45P | 9.0 | 3.0 | 2.0 | 3.0 | 3.0 | | 3.0 |
| | CATALOID SI-80 | | | | | | 3.0 | |
| SOLVENT | BTG (21.1) | 1.0 | 1.0 | 1.0 | 1.0 | 1.0 | 1.0 | 1.0 |
| | MTG (22.1) | 2.0 | 2.0 | 2.0 | 2.0 | 2.0 | 2.0 | 2.0 |
| | TEG (27.54) | 1.0 | 1.0 | 1.0 | 1.0 | 1.0 | 1.0 | 1.0 |
| | GLYCERIN (34.2) | 7.0 | 7.0 | 7.0 | 7.0 | 7.0 | 7.0 | 7.0 |
| SURFACTANT | OLFINE E1010 | 0.5 | 0.5 | 0.5 | 0.5 | 0.5 | 0.5 | 0.5 |
| | SURFYNOL 104 | 0.5 | 0.5 | 0.5 | 0.5 | 0.5 | 0.5 | 0.5 |
| AMINO ACID | TRIMETHYL GLYCINE | 6.0 | 6.0 | 6.0 | 6.0 | 6.0 | 6.0 | |
| WATER | | 60.0 | 66.0 | 69.0 | 69.0 | 66.0 | 66.0 | 66.0 |
| TOTAL | | 100 | 100 | 100 | 100 | 100 | 100 | 100 |
| SOLID CONTENT | | 15.0 | 10.0 | 6.0 | 6.0 | 10.0 | 10.0 | 10.0 |
| MASS RATIO (INORGANIC OXIDE PARTICLES/SILICATE) | | 9000 | 30 | | | 30 | 30 | 30 |
| SOLVENT S₁ HAVING SP VALUE OF 27.5 OR LESS/TOTAL SOLVENT (%) | | 27.27 | 27.27 | 27.27 | 27.27 | 27.27 | 27.27 | 27.27 |
| EVALUATION ITEM | COLOR DEVELOPMENT PROPERTY | B | B | C | C | B | A | A |
| | STORAGE STABILITY | B | A | A | A | A | A | B |
| | INTERMITTENT PRINTING STABILITY | B | A | A | A | B | B | B |
| | CLOGGING RECOVERY PROPERTY | B | A | A | A | B | B | B |
| | PRIMARY CURLING | A | B | B | B | B | A | B |
| | NOZZLE-PLATE HYDROPHOBIC PROPERTY | B | B | A | B | A | B | A |

*VALUE IN PARENTHESES OF SOLVENT: SP VALUE [(J/cm³)^{½}]

TABLE 3

| | | COMPARATIVE EXAMPLE | | | | | | |
|---|---|---|---|---|---|---|---|---|
| | | 1 | 2 | 3 | 4 | 5 | 6 | 7 |
| PIGMENT (CARBON BLACK) | RESIN DISPERSION | | | | | | | |
| | SELF DISPERSION | 7.0 | 7.0 | 7.0 | 7.0 | 7.0 | 7.0 | 7.0 |
| WATER-SOLUBLE SILICATE | POTASSIUM SILICATE | | 0.6000 | 1.0000 | | | 0.1000 | 0.1000 |
| | SODIUM SILICATE | | | | | | | |
| INORGANIC OXIDE PARTICLES | CATALOID SI-45P | | 3.0 | 3.0 | 3.0 | 2.0 | | |
| | CATALOID SI-80 | | | | | | | |
| SOLVENT | BTG (21.1) | 1.0 | 1.0 | 1.0 | 1.0 | 1.0 | 1.0 | 4.0 |
| | MTG (21.1) | 2.0 | 2.0 | 2.0 | 2.0 | 2.0 | 2.0 | 2.0 |
| | TEG (27.54) | 1.0 | 1.0 | 1.0 | 1.0 | 1.0 | 1.0 | 1.0 |
| | GLYCERIN (34.2) | 7.0 | 7.0 | 7.0 | 7.0 | 7.0 | 7.0 | 7.0 |
| SURFACTANT | OLFINE E1010 | 0.5 | 0.5 | 0.5 | 0.5 | 0.5 | 0.5 | 0.5 |
| | SURFYNOL 104 | 0.5 | 0.5 | 0.5 | 0.5 | 0.5 | 0.5 | 0.5 |
| AMINO ACID | TRIMETHYL GLYCINE | 6.0 | 6.0 | 6.0 | 6.0 | 6.0 | 6.0 | 6.0 |
| | WATER | 69.0 | 65.0 | 64.0 | 66.0 | 66.0 | 69.0 | 66.0 |
| | TOTAL | 100 | 100 | 100 | 100 | 100 | 100 | 100 |
| SOLID CONTENT | | 7.0 | 10.0 | 10.0 | 10.0 | 9.0 | 7.0 | 7.0 |
| MASS RATIO (INORGANIC OXIDE PARTICLES/SILICATE) | | | 5 | 3 | | | | |
| SOLVENT S₁ HAVING SP VALUE OF 27.5 OR LESS/TOTAL SOLVENT (%) | | 27.27 | 27.27 | 27.27 | 27.27 | 27.27 | 27.27 | 42.86 |
| EVALUATION ITEM | COLOR DEVELOPMENT PROPERTY | A | A | A | A | A | A | A |
| | STORAGE STABILITY | A | A | A | A | A | A | C |
| | INTERMITTENT PRINTING STABILITY | A | A | A | D | C | A | A |
| | CLOGGING RECOVERY PROPERTY | A | C | C | A | A | B | B |
| | PRIMARY CURLING | C | B | A | B | C | C | C |
| | NOZZLE-PLATE HYDROPHOBIC PROPERTY | B | A | A | C | C | B | B |

*VALUE IN PARENTHESES OF SOLVENT: SP VALUE [(J/cm³)^{½}]

### 3. Evaluation Result

In Tables 1 to 3, the compositions of the inks used in Examples and Comparative Examples and the evaluation results thereof are shown. From Tables 1 to 3, it is found that since the colorant, the inorganic oxide particles, and the predetermined amount of the water-soluble silicate, and the water are contained, the curling of the recorded matter to be obtained is suppressed, and in addition, although the ink contains the inorganic oxide particles, the clogging recovery property thereof is excellent.

In particular, according to Comparative Example 1, it is found that when the inorganic oxide particles are not used, the curling is liable to occur, and according to Comparative Examples 4 to 5, it is found that when the inorganic oxide particles are only contained, the water-repellent property of the nozzle plate and the intermittent printing stability are further degraded. Furthermore, according to Comparative Examples 2 to 3, it is found that when the amount of the water-soluble silicate is excessively high, the clogging recovery property is degraded.

What is claimed is:

1. An ink jet ink composition which is a water-based ink, comprising:
a colorant;
inorganic oxide particles;
a water-soluble silicate; and
water,
wherein a content of the water-soluble silicate with respect to a total mass of the ink is 0.5 percent by mass or less.

2. The ink jet ink composition according to claim 1,
wherein a content of the inorganic oxide particles with respect to the total mass of the ink is 1.0 to 10 percent by mass.

3. The ink jet ink composition according to claim 1,
wherein a content of a solid content including the colorant and the inorganic oxide particles with respect to the total mass of the ink is 5.0 percent by mass or more.

4. The ink jet ink composition according to claim 1,
wherein a content of the colorant with respect to the total mass of the ink is 0.5 to 10 percent by mass.

5. The ink jet ink composition according to claim 1,
wherein the content of the water-soluble silicate with respect to the total mass of the ink is 0.00001 to 0.5 percent by mass.

6. The ink jet ink composition according to claim 1,
wherein the colorant includes a self-dispersible pigment.

7. The ink jet ink composition according to claim 1,
wherein a ratio of a content of the inorganic oxide particles to the content of the water-soluble silicate (inorganic oxide particles/water-soluble silicate) is 3 to 50,000.

8. The ink jet ink composition according to claim 1, further comprising a water-soluble organic solvent,
wherein a content of a water-soluble organic solvent S₁ having an SP value of 27.5 (J/cm³)^{½} or less with respect to a total mass of the water-soluble organic solvent is 35 percent by mass or less.

9. The ink jet ink composition according to claim 1,
wherein a content of the water with respect to the total mass of the ink is 80 percent by mass or less.

10. The ink jet ink composition according to claim 1, further comprising an amino acid.

11. The ink jet ink composition according to claim 1,
wherein the ink jet ink composition is used for recording on an absorbing recording medium.

12. A recording method comprising:
ejecting the ink jet ink composition according to claim 1 from an ink jet head to a recording medium so as to be adhered thereto.
